(19) United States
(12) Patent Application Publication
(10) Pub. No.: US 2013/0208768 A1
(43) Pub. Date: Aug. 15, 2013

(54) UNDERWATER ACOUSTIC MULTIPLE-INPUT/MULTIPLE-OUTPUT (MIMO) COMMUNICATION SYSTEMS AND METHODS

(71) Applicants: Aijun Song, Bear, DE (US); Mohsen Badiey, Newark, DE (US)

(72) Inventors: Aijun Song, Bear, DE (US); Mohsen Badiey, Newark, DE (US)

(73) Assignee: University of Delaware, Newark, DE (US)

(21) Appl. No.: 13/642,704

(22) PCT Filed: Jun. 7, 2011
(86) PCT No.: PCT/US11/39378

§ 371 Date: Dec. 20, 2012

Related U.S. Application Data
(60) Provisional application No. 61/352,056, filed on Jun. 7, 2010.

(51) Int. Cl. H04B 15/00; H04B 13/02

(52) U.S. Cl. CPC H04B 15/00; H04B 13/02
USPC 375/218

(57) ABSTRACT

Methods and systems for acoustic multiple-input/multiple-output (MIMO) communication in an underwater environment. The method includes: a) receiving signals at multiple receivers representing transmitted signals from multiple transmitters, b) estimating channel responses between the multiple receivers and the multiple transmitters, c) performing an initial demodulation process on the received signals using the estimated channel responses to remove inter-symbol interference (ISI), and d) performing at least one subsequent demodulation process on the received signals. The subsequent demodulation process: i) removes co-channel interference (CoI) using the estimated channel responses and demodulated signals from an immediately preceding demodulation process to form interference cancelled signals and ii) removes ISI from the interference cancelled signals. In the initial and subsequent demodulation processes, ISI removal includes a time reversal combining process followed by a single-channel decision feedback equalization (DFE) process.

### CROSS-REFERENCE TO RELATED APPLICATIONS

The present application claims priority to U.S. Provisional Application Ser. No. 61/352,056, entitled UNDERWATER ACOUSTIC MULTIPLE-INPUT/MULTIPLE-OUTPUT (MIMO) COMMUNICATION SYSTEMS AND METHODS, the contents of which are incorporated fully herein by reference.

### STATEMENT REGARDING FEDERALLY SPONSORED RESEARCH

The present invention was supported in part by Grant Number N00014-16-1-0193 from the Office of Naval Research. The United States Government may have certain rights to the invention.

### FIELD OF THE INVENTION

The present invention relates to the field of underwater acoustic communication and, more particularly, to methods and systems for multiple-input/multiple-output (MIMO) communication in an underwater environment including a multi-stage demodulation process to remove inter-symbol interference (ISI) and co-channel interference (CoI).

### BACKGROUND OF THE INVENTION

The oceans are becoming an increasingly important source of many human related needs, ranging from the study of biomedical organisms for combating disease to their potential role as a future energy resource. Scientific missions and civilian activities in the oceans are expanding, especially in coastal zones. These activities have led to an increasing demand on high speed underwater wireless telemetry and data communications among distributed sensors, autonomous underwater vehicles (AUVs), moored instruments, and surface ships.

Conventional acoustic communication technologies typically use a single transmitter, which may have limited data rates due to the narrow bandwidth that is generally available in the underwater channel. The underwater channel may have extended multi-path spread, as well as rapidly changing characteristics (e.g., Doppler spread). The extensive, time-varying inter-symbol interference (ISI) that results from multi-path propagation is difficult to remove and, thus, seriously restricts the achievable data rate.

The underwater environment, however, is rich in spatial structure, as evidenced by the spatially dependent multi-path arrivals. It is known that a significant data rate increase may be achieved by simultaneously transmitting multiple data streams from a bank of transmitters, referred to herein as multiple-input/multiple-output (MIMO) communication. In general, with enough degrees of freedom in rich scattering environments, the channel capacity may increase with the number of transmitters and receivers. Therefore, MIMO communication may provide improved performance and increased capacity. A problem that arises in underwater acoustic MIMO communication, however, is co-channel interference (CoI) which results from the usage of multiple transmitters in addition to the ISI. Removal of both CoI and ISI is a challenging problem in the underwater channel.

### SUMMARY OF THE INVENTION

The present invention is embodied in methods and systems for acoustic communication in an underwater environment. The method includes: a) receiving signals at multiple receivers representing transmitted signals from multiple transmitters, b) estimating channel responses between the multiple receivers and the multiple transmitters, c) performing an initial demodulation process on the received signals using the estimated channel responses to remove ISI, and d) performing at least one subsequent demodulation process on the received signals. The subsequent demodulation process: i) removes CoI using the estimated channel responses and demodulated signals from an immediately preceding demodulation process to form interference cancelled signals and ii) removes ISI from the interference cancelled signals. In the initial and subsequent demodulation processes, ISI removal includes a time reversal combining process followed by a single-channel decision feedback equalization (DFE) process.

### BRIEF DESCRIPTION OF THE DRAWINGS

The invention may be understood from the following detailed description when read in connection with the accompanying drawings. It is emphasized that, according to common practice, various features of the drawings may not be drawn to scale. On the contrary, the dimensions of the various features may be expanded or reduced for clarity. Moreover, in the drawings, common numerical references are used to represent like features. Included in the drawings are the following figures:

FIG. 1 is a functional block diagram illustrating an exemplary acoustic communication system, according to an embodiment of the present invention;

FIG. 2 is a functional block diagram illustrating an exemplary transmission system of the communication system shown in FIG. 1, according to an embodiment of the present invention;

FIG. 3 is a functional block diagram illustrating an exemplary reception system of the communication system shown in FIG. 1, according to an embodiment of the present invention;

FIG. 4 is a functional block diagram illustrating an exemplary demodulation system of the reception system shown in FIG. 3, according to an embodiment of the present invention;

FIG. 5 is a functional block diagram illustrating an exemplary demodulation block of the demodulation system shown in FIG. 4, according to an embodiment of the present invention;

FIG. 6 is a functional block diagram illustrating an initial demodulation stage of the demodulation system shown in FIG. 4, according to an embodiment of the present invention;

FIG. 7 is a functional block diagram illustrating a subsequent demodulation stage of the demodulation system shown in FIG. 4, according to an embodiment of the present invention;

FIG. 8A is a flow chart diagram illustrating an exemplary method for communication in an underwater environment, according to an aspect of the present invention;

FIG. 8B is a flow chart diagram illustrating a method for initializing parameters of the communication method shown in FIG. 8A, according to an aspect of the present invention;

FIG. 9 is a cross-section diagram of an example communication system in an underwater acoustic environment shown with a sound speed profile (SSP), according to an embodiment of the present invention;

FIG. 10 is a cross-section diagram of another example communication system in an underwater acoustic environment, according to an embodiment of the present invention;

FIG. 11A is a graph temperature profiles of the underwater environment of FIG. 10 illustrating the positions of the transmitters and receivers, according to an embodiment of the present invention; and

FIG. 11B is a graph of output signal-to-noise ratio (SNR) as a function of geotime for demodulation of data packets of the exemplary communication system shown in FIG. 10, according to an embodiment of the present invention.

### DETAILED DESCRIPTION OF THE INVENTION

As a general overview, and as will be described in detail below, the present invention is related to methods and systems for communication in an underwater environment through the use of MIMO techniques. An exemplary method may include receiving signals at multiple receivers representing transmitted signals from multiple transmitters, estimating channel responses between the receivers and the transmitters and performing a multi-stage demodulation process. The multi-stage demodulation process may include performing an initial demodulation process on the received signals using the estimated channel responses to remove ISI and performing at least one subsequent demodulation process on the received signals. The subsequent demodulation process may remove CoI using the estimated channel responses and demodulated signals from an immediately preceding demodulation process to form interference cancelled signals and may remove ISI from the interference cancelled signals. According to aspects of the present invention, the received signal may also be corrected for Doppler effects and for carrier phase fluctuations, prior to the channel estimation. According to an exemplary embodiment, the channel estimation may involve sparse estimators. The ISI may be removed by a time reversal and DFE process using the estimated channel responses.

Conventional multichannel decision feedback equalizers have been extended to multiuser (asynchronous MIMO) systems to jointly compensate for CoI and ISI, with feedback loops used to remove interference from other transmitters for each data stream. The complexity of these processors, however, may increase quadratically with the total number of filter tap coefficients, which in turn may increase with the product of the number of transmitters (N_{T}) and the number of receivers (N_{R}). Accordingly, the processing load may become computationally prohibitive when the product of N_{T} and N_{R} increases.

In order to perform acoustic MIMO communication, an alternative strategy may be to process the signals from each transmitter separately, by treating the signals from other transmitters as interference, which is estimated and subtracted in order to estimate each signal. Both serial and parallel interference cancellation (IC) techniques are generally known. For example, IC techniques have been investigated in the presence of ISI under the framework of radio-frequency cellular spread spectrum communication. In the acoustic MIMO system, both layered space time codes and space time trellis codes may be used on the transmitter side. In the former, data streams are individually coded for each transmitter, whereas the latter spreads the code over space and time. Iterative equalization processes may be applied to the receiver side where soft information (e.g., the log likelihood probability) is looped between the DFE and the channel decoder. Iterative equalization, for example, has been shown to reduce the BER in MIMO underwater acoustic communications, using either iterative MIMO-multichannel DFE or multichannel DFE with serial IC. However, these conventional algorithms typically have high implementation complexity. Aspects of the present invention provide low-complexity physics-based solutions to acoustic MIMO communication in the dynamic underwater environment.

As used herein, a variable with ̂ denotes the estimate of the variable, ∥·∥² denotes the L₂-norm of a vector, c* denotes the complex conjugate of a complex number c, a(n)\textcircled{×}b(n) denotes the convolution of two sequences a(n) and b(n), and X^{T} and X^{H} denote the transpose and conjugate transpose of the matrix X, respectively. All time information regarding the example experiments described below is in Coordinated Universal Time (UTC) unless stated otherwise.

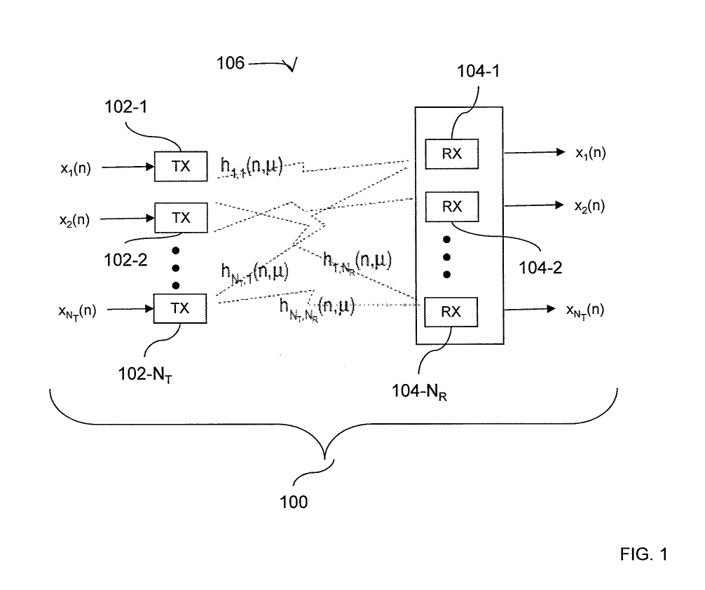

Referring to FIG. 1, a functional block diagram of a general MIMO communication system 100 having N_{T} transmitters 102 (e.g., transducers) and N_{R} receivers 104 (e.g., hydrophones) will now be described. In communication system 100, N_{T} may or may not be equal to N_{R}. Communication 100 is provided in an underwater environment, where the environment may be characterized by channel impulse responses (also referred to herein as channel responses), designated generally as 106, between transmitters 102 and receivers 104. Receivers 104 receive multiple data streams x_{I}(n) (where I is an integer from 1 to N_{T}) from multiple transmitters 102, modified by the channel responses 106, and desirably estimate the data streams (also referred to herein as information sequences) from the respective transmitters 102, where the estimated data streams are represented by ̂ₗ(n).

At the I-th transmitter 102-I of the source transmission, an information sequence x_{I}(n) is modulated to carrier frequency f_{c} and transmitted. N_{T} symbol sequences from N_{T} transmitters 102 may be independent of each other, but may use the same symbol rate R and carrier frequency f_{c}. Let uₘ(t) be the received baseband waveform at the m-th receiver 104 (where m is an integer between 1 and N_{R}). After Doppler correction and digitization (described further below), yₘ(n) represents the discrete baseband signal. The effect of the transmission medium between the I-th transmitter 102 and the m-th receiver 104 may be characterized by a time-varying channel impulse response, h_{l,m} (n, μ), 0≦μ≦L-1, where L is the discrete channel length.

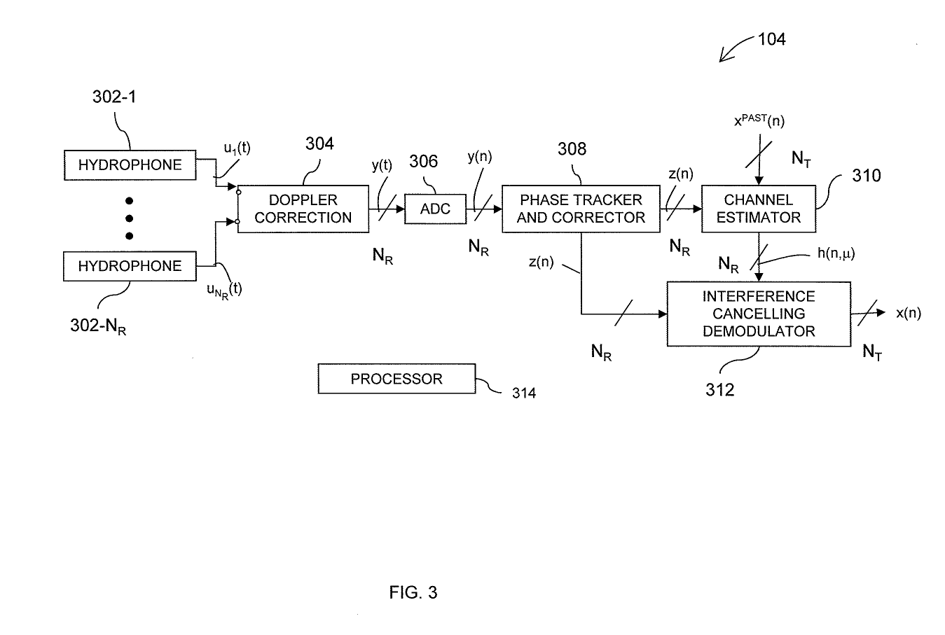

The received signal on the m-th receiver 104 (yₘ(n)) (after Doppler correction and digitization, described below with reference to FIG. 3) may be represented by the summation of all symbol sequences distorted by the channel, i.e.,

$${y}_{m} ( n ) = {\sum }_{l = 1}^{{N}_{T}} {e}^{j {θ}_{l , m} ( n )} [ {x}_{l} ( n ) ⊗ {h}_{l , m} ( n , μ ) ] + {v}_{m} ( n ) , \qquad ( 1 )$$

where θ_{l,m} (n) is the instantaneous carrier phase offset associated with the I-th symbol sequence at the m-th receiver 104, and vₘ(n) represents the ambient noise received at the m-th receiver 104.

A primary challenge in underwater acoustic communication arises from the typically highly dispersive and fast fluctuating characteristics of the channel. It is common for the channel to have a delay spread on the order of tens of milliseconds. At high data rates, this may translate into more than tens of symbols in the discrete channel length. Furthermore, multiple hydrophones are often employed to achieve an acceptable performance in dynamic ocean environments. The recovery of source information from multiple excessively long channels is often implemented at high orders of complexity. In MIMO systems, the implementation complexity may be more severe because multiple data streams share the channel and may interfere with each other in the demodulation process.

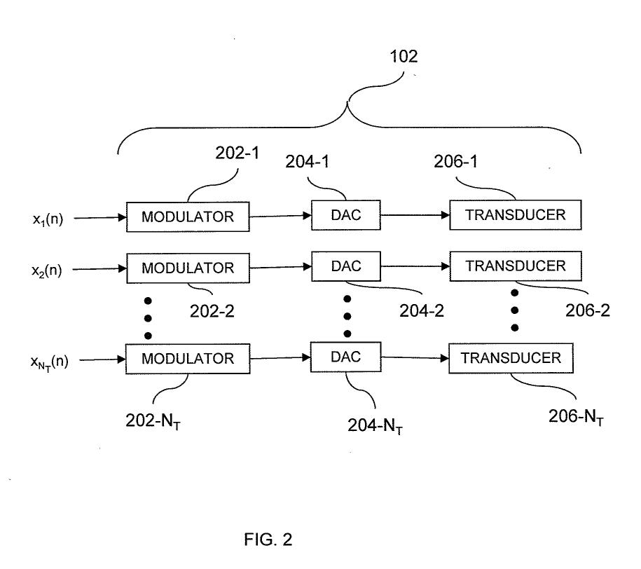

Referring to FIG. 2, a functional block diagram an exemplary transmitter system 102 is shown. The illustrated transmitter system 102 includes modulators 202, digital-to-analog converters (DACs) 204, and N_{T} number of transducers 206. Although separate modulators 202 and DACs 204 are shown, a single modulator 202 and DAC 204 may be used for the plurality of transducers 206. All of these components may be controlled by a processor (not shown). Suitable components for use within transmitter system 102 will be understood by one of skill in the art from the description herein.

Modulators 202 may map information data to a constellation such that modulated symbols are provided. The constellation may include, but is not limited to, a pulse amplitude modulation (PAM), a phase shift keying (PSK), or a quadrature modulation (QAM) constellation. DACs 204 convert the modulated symbols to analog signals at the carrier frequency, which are then transmitted by respective transducers 206.

Referring to FIG. 3, a functional block diagram of an exemplary receiver system 104 is shown. Receiver system 104 includes N_{R} hydrophones 302-1, . . . , 302-N_{R}, Doppler correction block 304, analog-to-digital converter (ADC) 306, phase tracker and corrector 308, channel estimator 310 and interference canceling demodulator 312. All of these components may be controlled by a processor 314. For the sake of clarity, connections between processor 314 and the elements of receiver system 104 are not shown in FIG. 3. Suitable components for use within receiver system 104 will be understood by one of skill in the art from the description herein.

Doppler correction block 304 receives signals uₘ(t) (for m=1, . . . , N_{R}) from respective hydrophones 302 and removes any Doppler shift introduced by platform movement. Let sₘ(t) be the received baseband analog signal without any Doppler effects at the m-th receiving hydrophone 302-m. The Doppler distorted signal may be represented as uₘ(t)=sₘ((1+β)t)exp(j2πf_{c}βt), where β is a time compression/dilation factor, β≈v/c, where v is the relative velocity of the transmitter heading toward a receiver and c is the sound speed. The time compression/dilation factor β may be estimated by:

$$\hat{β} = arg {max}_{β} {\int }_{t}^{0} {T}_{D} {u}_{m} ( t ) ( {x}_{l} ( ( 1 + β ) t ) {e}^{j 2 π {f}_{c} β t} ) * d t , \qquad ( 2 )$$

where xₗ(t) represents the analog baseband signal emitted from the I-th transmitter 102 (FIG. 1) and T_{D} represents the estimation period. Often xₗ(t) represents the signal from the deepest transmitter 102 (FIG. 1) if the ocean environment is downward reflecting. An estimation period T_{D} of between about 100 ms to about 200 ms typically provides an accurate estimate of β. The preamble of the information sequence, or a known sequence of symbols, may be used to perform Doppler correction, as well as for initialization of other parameters, such as for channel estimator 310.

Doppler correction may be performed by re-sampling the received signal uₘ(t) as:

$${y}_{m} ( t ) = {u}_{m} ( \frac{t}{1 + \hat{β}} ) exp ( - j 2 π {f}_{c} \frac{\hat{β} t}{\hat{β} + 1} ) , m = 1 , 2 , … , {N}_{R} \qquad ( 3 )$$

ADC 306 receives Doppler corrected signals uₘ(t) (for m=1, . . . , N_{R}) and converts the signals to digital signals yₘ(n), which may be used for further processing and demodulation.

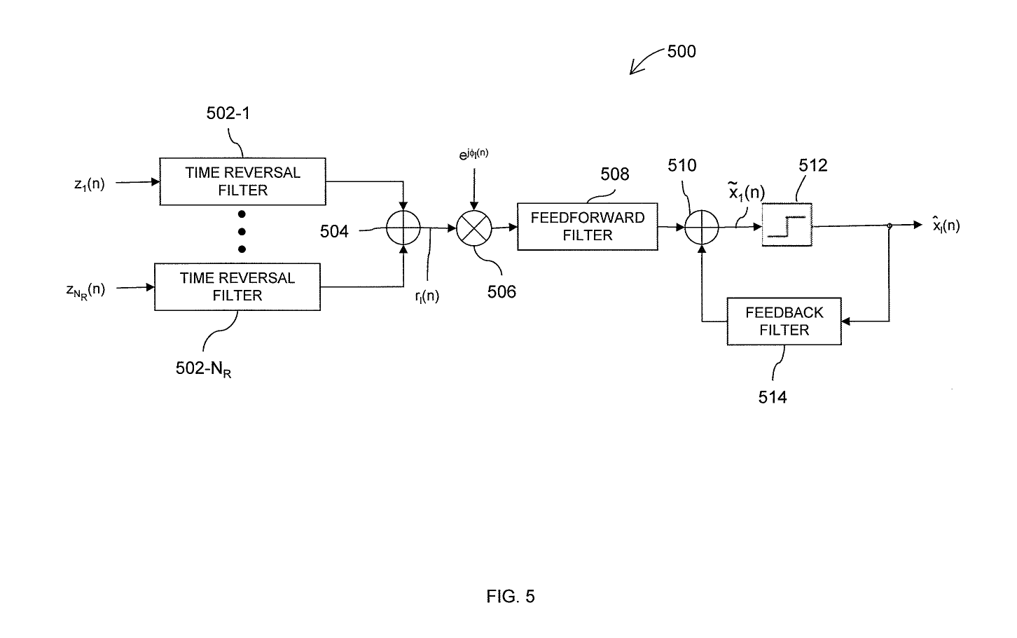

Phase tracker and corrector 308 receives digitized signals yₘ(n) and may compensate for any linear trends in the fast carrier phase fluctuations. It is assumed that the signals received by phase tracker and corrector 308 have been compensated for Doppler shift (by re-sampling the received signals by Doppler correction). Even after Doppler compensation, fast phase fluctuations may exist in the high frequency (e.g., about 10-50 kHz) acoustic channel due to temporal variations of the ocean, imperfections in the source and the receiver, etc. The Doppler and phase fluctuations may be corrected three times in receiver system 104. First, the bulk Doppler shift is compensated for in the broadband by re-sampling of the received signals. Second, the linear trend of fast phase fluctuations may be estimated at the individual hydrophone channels. The phase fluctuations may be removed as the phase trend in the narrowband. Lastly, any residual phase offsets at the input to ISI cancellation demodulator block 500 (FIG. 5) may be compensated for by a phase locked loop (PLL) embedded in ISI cancellation demodulator block 500.

At the m-th hydrophone 302, it may be assumed that all of the symbol sequences have similar phase offsets, because the source aperture is typically much smaller than the water depth and the range, i.e., θₘ [symbol] θ_{1,m}=θ_{2,m}= . . . =θ_{N}_{_{T}}_{,m}. Accordingly, the phase fluctuation at the m-th hydrophone may be modeled as, θₘ (n)=2πnξₘ(n)Tₛ, where ξₘ(n) is the linear trend of the carrier phase offset and Tₛ is the symbol period. The phase trend estimate may be obtained by:

$${\hat{ξ}}_{m} ( n ) = arg {max}_{ξ} \vert {\sum }_{p = 0}^{{N}_{ξ} - 1} {y}_{m} ( n - p ) ( {\hat{y}}_{m} ( n - p ) {e}^{j 2 π p ξ {T}_{s}} ) * \vert , \qquad ( 4 )$$

where N_{ξ} represents the phase observation block size in symbols, ŷₘ(n)=Σₗ₌₁^{N}^{_{T}} \hat{x}ₗ^{Past} (n)\textcircled{×}ĥ_{l,m}(n, μ), and \hat{x}ₗ^{Past}(n) represents past demodulation results. The phase correction may be performed by offsetting the received signal yₘ(n) by the estimated phase trend, i.e.,

zₘ(n)=yₘ(n)e^{-j2m\hat{ξ}}_{ₘ}^{(n)T}, (5)

where zₘ(n) denotes the phase-corrected signal.

Channel estimator 310 performs MIMO channel estimation based on the received phase-corrected signals zₘ(n) and the past demodulation results \hat{x}ₗ^{Past} (n) at multiple symbol sequences. The most recent channel estimates from channel estimator 319 may also be used in phase tracking (phase tracker and corrector 308) and demodulation (demodulator 312).

Assuming that the phase offsets are removed completely in Eq.(5), the phase-corrected signal zₘ(n) may be represented as:

$${z}_{m} ( n ) = {\sum }_{l = 1}^{{N}_{T}} {x}_{l} ( n ) ⊗ {h}_{l , m} ( n , μ ) + {η}_{m} ( n ) , \qquad ( 6 )$$

where ηₘ(n) represents the noise term after phase correction. As in single transmitter systems, the estimate of h_{l,m} (n,l) may be obtained from the phase-corrected received signal during an observation period and h_{l,m}(n,l) may be assumed constant in the period.

For an observation block ending at epoch n, Eq. (6) can be written in a matrix form:

$${z}_{m} ( n ) = X ( n ) {h}_{m} ( n ) + {η}_{m} ( n ) , \\ where \\ {z}_{m} ( n ) = {[ {z}_{m} ( n ) {z}_{m} ( n - 1 ) … {z}_{m} ( n - {N}_{0} + 2 ) ]}^{T} , \\ X ( n ) = [ \begin{matrix}{x}_{1} ( n ) & … & {x}_{NT} ( n ) & … & {x}_{1} ( n - L + 1 ) & … & {x}_{NT} ( n - L + 1 ) \\ {x}_{1} ( n - 1 ) & … & {x}_{NT} ( n - 1 ) & … & {x}_{1} ( n - L ) & … & {x}_{NT} ( n - L ) \\ … & … & … & … & … & … & … \\ {x}_{1} ( n - {N}_{0} + 1 ) & … & {x}_{NT} ( n - {N}_{0} + 1 ) & … & {x}_{1} ( n - {N}_{0} - L + 2 ) & … & {x}_{NT} ( n - {N}_{0} - L + 2 )\end{matrix} ] , \\ {h}_{m} ( n ) = {[ {h}_{1 , m} ( n , 0 ) … {h}_{{n}_{T} , m} ( n , 0 ) … {h}_{1 , m} ( n , L - 1 ) … {h}_{{N}_{T} , m} ( n , L - 1 ) ]}^{T} , and \\ {η}_{m} ( n ) = {[ {η}_{m} ( n ) {η}_{m} ( n - 1 ) … {η}_{m} ( n - {N}_{0} + 1 ) ]}^{T} . \qquad ( 7 )$$

Based on Eq.(7), various algorithms, such as least squares (LS) and matching pursuit (MP) algorithms, may be used to estimate the impulse responses related to the N_{T} transmitters 102, similar to channel estimation in single transmitter systems.

For example, the least squares (LS) solution is:

ĥₘ(n)=(X^{H}(n)X(n))⁻¹X^{H}(n)zₘ(n). (8)

An example of the MP algorithm is described below. For simplicity, Eq.(7) is re-shown without the time and transmitter indexes as:

z=Xh+η (9)

In Eq. 9, X=Øx₁ x₂ . . . x_{LN}_{_{T}}┘ and xₖ are the k-th column of the symbol matrix X, h=[h₁ h₂ . . . h_{LN}_{_{T}}]^{T} and hₖ is the k-th tap of the MIMO channel vector h.

In the general MP algorithm, the phase-corrected received signal z may be approximated by the linear combination of the columns xₖ with ĥₖ as the linear coefficients. The dominant taps of h are identified and estimated sequentially in an iterative manner. First, the column in the symbol matrix that is best aligned with z is identified and denoted as xₛ_{₁}. A residual signal vector z₁ is obtained by removing the projection of z on xₛ_{₁} from z. Then at the p-th iteration, the column out of the remaining columns xₖ, k≠s₁, . . . , sₚ₋₁, that is best aligned with the residual signal vector zₚ₋₁ is identified and denoted as xₛ_{ₚ}. A new residual signal vector zₚ is generated by removing the projection of zₚ₋₁ on xₛ_{ₚ}.

At the p-th iteration, the projection of residual signal vector zₚ₋₁ onto a column xₖ is defined as

$${p}_{{x}_{k}} = \frac{{x}_{k}^{H} {z}_{p - 1} {x}_{k}}{{‖ {x}_{k} ‖}^{2}} . \qquad ( 10 )$$

The criterion to measure the alignment between the column of the symbol matrix and the residual signal vector is the L₂ norm of the projection. The p-th dominant path of h is identified as

$${s}_{p} = arg {max}_{k} \frac{{\vert {x}_{k}^{H} {z}_{p - 1} \vert}^{2}}{{‖ {x}_{k} ‖}^{2}} , k \neq {s}_{1} , … , {s}_{p - 1} , \qquad ( 11 )$$

and its estimate is obtained as

$${\hat{h}}_{{s}_{p}} = \frac{{x}_{{s}_{p}}^{H} {z}_{p - 1}}{{‖ {x}_{k} ‖}^{2}} . \qquad ( 12 )$$

The residual signal vector then is updated as

zₚ=zₚ₋₁−pₓ_{ₛₚ}=zₚ₋₁−ĥₛ_{ₚ}xₛ_{ₚ}. (13)

The iterative procedure stops after a pre-determined number of dominant taps have been estimated. The ratio between the number of the estimated taps P and the number of total channel taps is defined as the sparse ratio

$$α = \frac{P}{{LN}_{T}}$$

of the estimated channel.

In a non-training mode, channel estimation may be performed based on the past demodulation results. When the channel estimates are available, they may be used to demodulate the next block of the received signals from the N_{T} transmitters 102 (FIG. 1) under the assumption that the channel estimates can provide a reasonable prediction for these symbols. The block length is defined as T_{N}=N/Tₛ, so that the demodulation of each block generates estimates for NN_{T} transmitted symbols from N_{T} transmitters 102 (FIG. 1).

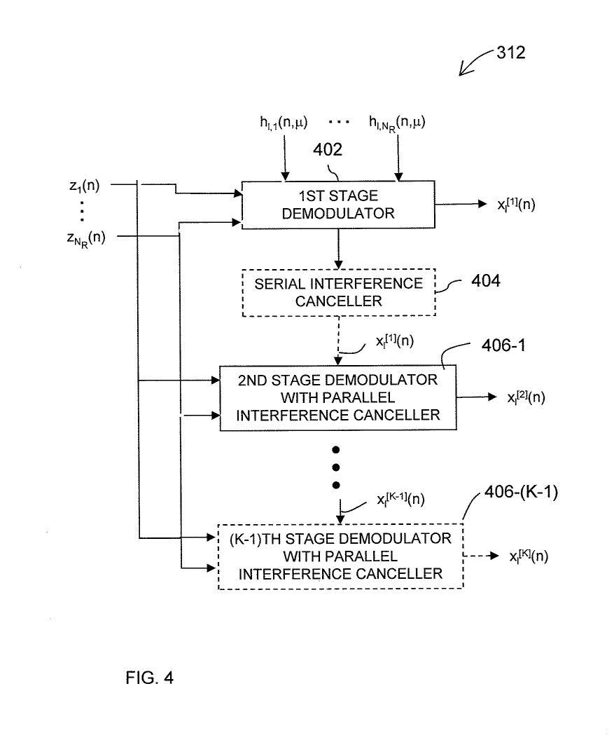

The underwater channel is sparse, which means that there only exist limited dominant paths. It may be advantageous to use sparse channel estimation algorithms to estimate only the dominant channel taps, both in view of the computational complexity and the equalizer performance. For example, according to experimental results, described further below, only about 20% of channel taps of hₘ(n) in Eq. 7 may be estimated and updated in the MIMO channel estimator 310. This may result in a significant reduction in computational complexity. Furthermore, the usage of only dominant channel taps is desirable to the performance of the multi-stage IC blocks (described below with respect to FIG. 4) of demodulator 312 and to channel estimator 310. In fact, IC using non-sparse channel estimation, in many cases, may not lead to performance enhancement. On the other hand, the sparse channel estimation results in robust, significant performance improvements. This may be due to the fact that the estimates of the non-dominant paths often are erroneous in a noisy environment and that the IC based on these erroneous taps may introduce errors.

The MP algorithm, for example, is naturally a sparse technique if the pre-determined number of dominant taps is less than the channel length. An example sparse LS algorithm for channel estimation is next described. If the positions of the nonzero taps of the channel h are known, the sparse LS algorithm can be formulated as:

z=Xₛhₛ+θ, (14)

where hₛ denotes the channel with only nonzero taps and Xₛ is the matrix composed of the data matrix columns that associate only with the nonzero channel taps. The sparse estimation can be obtained as ĥₛ=(Xₛ^{H}Xₛ)⁻¹Xₛ^{H}z. The P strongest taps of the non-sparse estimate ĥ can be chosen as the nonzero channel taps. Although the channel fluctuates rapidly, the nonzero channel tap positions do not typically vary quickly. Therefore, these tap positions may be estimated during the preamble and updated occasionally in a data packet.

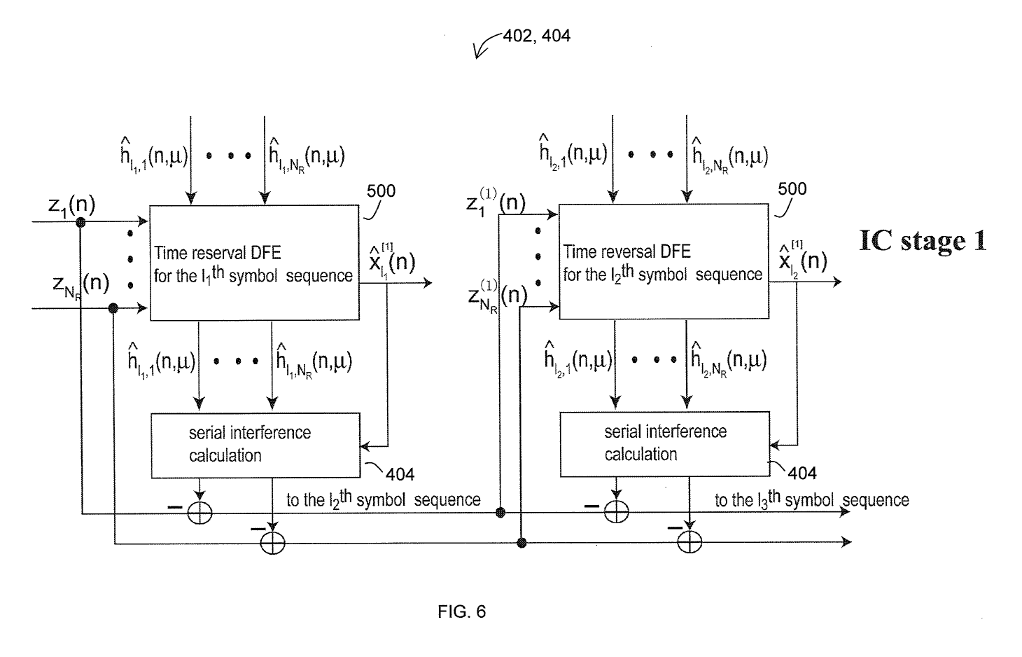

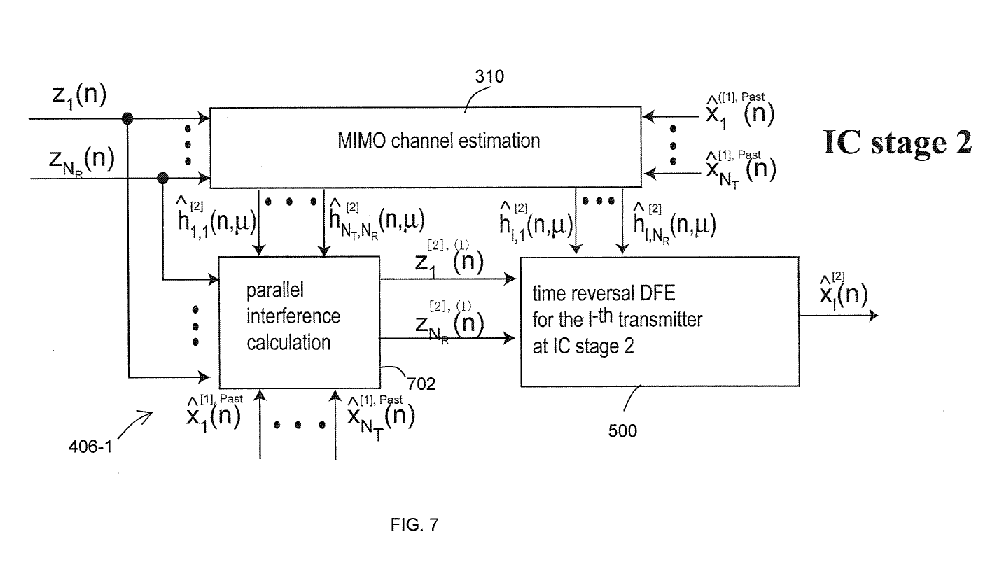

Referring next to FIG. 4, a functional block diagram of interference canceling demodulator 312 is shown. Demodulator 312 includes first stage demodulator 402, optional serial interference canceller 404, and K-1 subsequent stages of demodulators 406-1, . . . , 406-(K-1), where K is an integer and K≧1. Accordingly, when K≧2, interference canceling demodulator 312 represents a multi-stage IC demodulation process. Each demodulation stage 402 and 406 includes a demodulation process which removes ISI, by a time reversal DFE process, described below with respect to FIG. 5. First stage demodulator 402 performs an initial demodulation process, as described further with respect to FIG. 6. Demodulators 406 provide parallel IC, in order to mitigate CoI, as described further with respect to FIG. 7.

Referring to FIG. 5, a functional block diagram of a time reversal-DFE (TR-DFE) demodulator 500 is shown. TR-DFE demodulator 500 includes time reversal filters 502-1, . . . , 502-N_{R}, summation block 504, multiplier 506, feedforward filter 508, summation block 510, decision block 512 and feedback filter 514. Time reversal filters 502 and summation block 504 represent time reversal filtering. Multiplier 506, feedforward filter 508, decision block 512 and feedback filter 514 represent DFE. In TR-DFE demodulator 500, time reversal combining is first performed and a subsequent single channel DFE is then used to demodulate individual symbol sequences. Suitable components for use within TR-DFE demodulator 500 will be understood by one of skill in the art from the description herein.

Time reversal combining uses time reversal filters 502 ((ĥ_{l,m}(n,−μ))*) to match-filter the phase-corrected signals on each channel zₘ(n) and then combines the results using summation block 504. The output of time reversal combining is:

$$\begin{matrix}{r}_{l} ( n ) = {\sum }_{m = 1}^{{N}_{R}} ( {\hat{h}}_{l , m} ( n , - μ ) ) * ⊗ {z}_{m} ( n ) \\ = {x}_{l} ( n ) ⊗ {q}_{l} ( n , μ ) + \\ {\sum }_{{l}^{′} = 1 , {l}^{′} = l}^{{N}_{T}} {x}_{{l}^{l}} ( n ) ⊗ ( {\sum }_{m = 1}^{{N}_{R}} ( {\hat{h}}_{l , m} ( n , - μ ) ) * ⊗ {h}_{{l}^{l} , m} ( n , μ ) ) + \\ {w}_{l} ( n ) .\end{matrix} \qquad ( 15 )$$

In the second line of Eq. (15), the first term on the right-hand side contains the desired signal xₗ(n). qₗ(n, μ) is the effective impulse response (or the q-function) between the I-th transmitter 102 (FIG. 1) and the receiver 104, which can be computed as follows:

$${q}_{l} ( n , μ ) = {\sum }_{m = 1}^{{N}_{R}} ( {\hat{h}}_{l , m} ( n , - μ ) ) * ⊗ {h}_{l , m} ( n , μ ) . \qquad ( 16 )$$

The second term is the CoI from the other data streams. The third term, wₗ(n), is the noise component:

$${w}_{l} ( n ) = {\sum }_{m = 1}^{{N}_{R}} ( {\hat{h}}_{l , m} ( n , - μ ) ) * ⊗ ( {η}_{m} ( n ) ) . \qquad ( 17 )$$

The single channel DFE with joint phase tracking, as shown in FIG. 5, equalizes the residual ISI in rₗ(n). Multiplier 506 multiplies the combined signal rₗ(n) by a phase term, e^{jφ}^{ₗ}⁽ⁿ⁾, which represents a second order phase-locked loop (PLL). Any residual phase offset in rₗ(n) may be corrected by the second order PLL embedded in the DFE, prior to the input to feedforward filter 508. Feedforward filter 508 and feedback filter 514 represent equalizers. A suitable algorithm, such as a recursive least-squares (RLS) algorithm, may adaptively updates the equalizer tap weights of feedforward filter 508 and feedback filter 514. A soft output SNR, ρ_{I}, of the I-th DFE and the overall bit-error-rate (BER) of the receiver may be used as performance metrics for the demodulation results.

In TR-DFE demodulator 500, each symbol sequence is demodulated without considering the interference from other sequences. In order to mitigate the CoI, an IC scheme (demodulators 406 of FIG. 4) is incorporated into the receiver structure, as described below with respect to FIG. 7.

Referring to FIG. 6, a functional block diagram of first stage demodulator 402 and optional serial interference canceller 404 are shown. First stage demodulator 402 performs an initial demodulation process using TR-DFE demodulator 500, based on the estimated channel responses ĥ_{l,m}(n, μ) and the phase corrected signals zₘ(n), to generate initial demodulated signals \hat{x}ₗ^{[1]}(n).

Optional serial interference canceller 404 may receive the initial demodulated signals to serially remove interference based on the strength of the symbol sequences. In order to perform serial IC, the symbol sequences are demodulated in the order of the soft output SNRs of the single channel DFEs. The soft output SNR for each symbol sequence may be calculated during the preamble, for example. The strongest symbol sequence, denoted as the I₁-th sequence, is demodulated first. After the I₁-th symbol sequence is demodulated, its contribution to the received signal, which is viewed as interference by others, is removed. The receiver then proceeds to demodulate the next strongest symbol sequence. Accordingly, the input to the i-th core demodulator is,

zₘ⁽ⁱ⁾(n)=zₘ⁽ⁱ⁻¹⁾(n)−\hat{x}ₗ_{ᵢ₋₁}(n)\textcircled{×}ĥₗ_{ᵢ₋₁}ₘ(n, μ), i=2, 3, . . . , N_{T} (18)

where zₘ^{(l)} (n)=zₘ(n) feeds to the first core demodulator to detect the strongest symbol sequence. The demodulation results as shown in FIG. 6 may be used either as final results or in a next stage 406-1 (FIG. 4) for parallel IC. Because serial interference canceller 404 removes interference according to the signal strength, serial interference canceller 404 may remove the CoI for some of the data streams, without removing CoI for all of the data streams. Thus, serial interference canceller 404 may generally suppress the CoI across the data streams.

Referring next to FIG. 7, a functional diagram of a second stage demodulator 406-1 is shown. Demodulator 406-1 includes parallel interference canceller 702 and TR-DFE demodulator 500. Parallel interference canceller 702 uses immediately preceding demodulation outputs (e.g., \hat{x}ₘ^{[1]}(n)) and the channel response estimates ĥ_{l,m}(n, μ) to remove CoI from phase corrected signals zₘ(n). TR-DFE demodulator 500 uses the interference corrected signals zₘ^{[2],(1)}(n) for the demodulation.

Referring to FIGS. 4, 6, and 7, after first stage demodulator 402 (or serial interference canceller 404), channel estimates may be updated using the tentative demodulation results and the phase-corrected signals in the current demodulation block. With tentative demodulation results \hat{x}ₗ^{[1]}(n) and current channel estimates ĥ_{l,m}^{[2]}(n, μ), the parallel IC is performed for each symbol sequence and the demodulation is conducted based on the interference-removed signals. Because the interference from all other sources is removed for each sequence, demodulation results may be improved. With improved demodulation results, the IC procedure may continue in the next stage (e.g., demodulator 406-2). The channel estimation quality may also improve and may lead to improved demodulation results. The demodulation results at the K-th stage \hat{x}ₗ^{[K]}(n) are the final decision results.

The input to the i-th TR-DFE demodulator at the k-th interference stage is:

$${z}_{m}^{[ k ] , ( i )} ( n ) = {z}_{m} ( n ) - {\sum }_{l \neq i} {\hat{x}}_{l}^{[ k - 1 ]} ( n ) ⊗ {\hat{h}}_{l , m}^{[ k ]} ( n , μ ) , i = 1 , … , {N}_{T} \qquad ( 19 )$$

These IC schemes (i.e., eq. 18 and eq. 19) may desirably use the dominate channel taps to effectively combat the CoI. These dominate taps may be selected from full channel estimation and be directly estimated from the sparse estimators such as the sparse LS and MP algorithms, as described above.

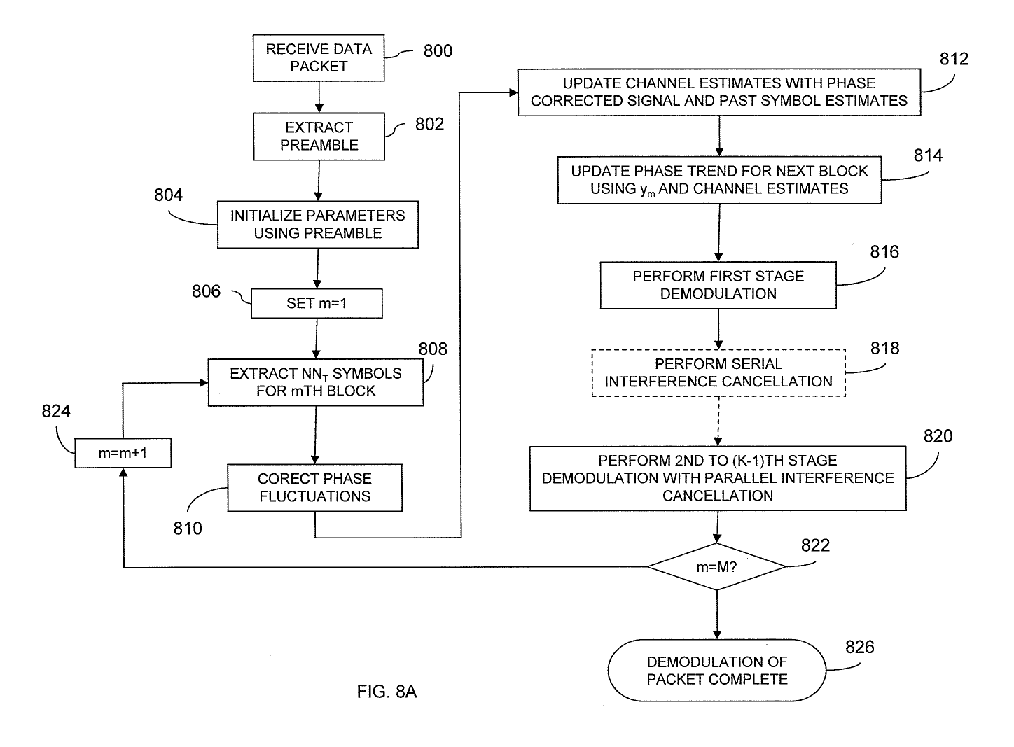

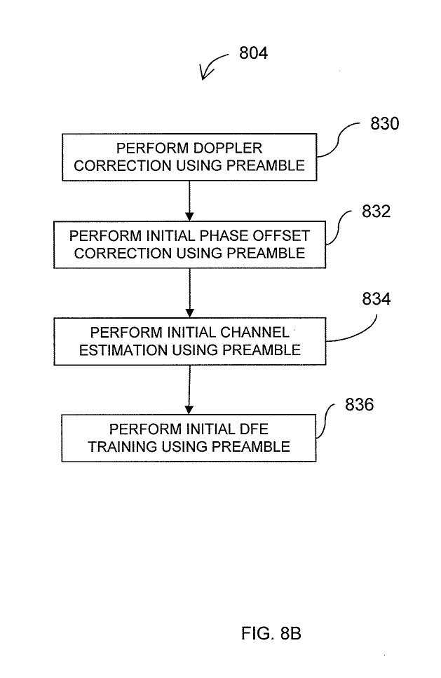

Referring next to FIGS. 8A-8B, flowchart diagrams illustrating an exemplary method for communication in an underwater environment are shown. In particular, FIG. 8A illustrates communication steps upon receipt of a data packet; and FIG. 8B illustrates the step of parameter initialization (step 804).

Referring to FIG. 8A, at step 800, a data packet is received, for example, by hydrophones 302 (FIG. 3). At step 802, the preamble is extracted from the data packet, for example, by processor 314 (FIG. 3). At step 804, parameters for receiver system 104 are initialized using the preamble, as described below with respect to FIG. 8B.

Referring to FIG. 8B, initialization of the parameters (step 804) is shown. At step 830, Doppler correction is performed using the preamble, for example, by Doppler correction block 304 (FIG. 3). The data packet may be re-sampled and digitized based on the Doppler estimation, for example, by ADC 306 (FIG. 3). At step 832, initial phase offset correction is performed using the preamble, for example, by phase tracker and corrector 308 (FIG. 3). At step 834, initial channel estimation is performed using the preamble, for example, by channel estimator 310 (FIG. 3). At step 836, initial DFE tap weight training is performed using the preamble, for example, by demodulator 312 (FIG. 3).

Referring back to FIG. 8A, at step 806, a demodulation block index (m) is initialized, for example, by processor 314 (FIG. 3). At step 808, NN_{T} symbols are extracted for the current demodulation block, for example, by processor 314 (FIG. 3). In general, in steps 808-820, the phase offsets are tracked and the symbol sequences are demodulated based on channel estimates, which are re-calculated at an interval T_{N}. Thus, communication data may be processed in a demodulation block of NN_{T} symbols.

At step 810, phase fluctuations are corrected for the received signal at individual channels, for example, by phase tracker and corrector 308 (FIG. 3). At step 812, MIMO channel estimation is performed, based on past demodulation results and the phase-corrected signals, for example by channel estimator 310 (FIG. 3). At step 814, phase trend estimates are calculated with updated channel estimates, for example, by phase tracker and corrector 308 (FIG. 3).

At step 816, a first stage demodulation is performed, for example, by first stage demodulator 402 (FIG. 4). At optional step 818, serial IC is performed, for example, by serial interference canceller 404 (FIG. 4). At step 820, K-1 stages of demodulation with parallel IC is performed, for example by demodulators 406 (FIG. 4). At step 820, N symbols from one transmitter 102 (FIG. 1) are processed by time reversal DFE enhanced by the multi-stage IC. After the NN_{T} symbols of the block are demodulated, step 820 proceeds to step 822.

At step 822, it is determined whether, the last demodulation block (i.e., M) is reached, for example, by processor 314 (FIG. 3). If the last demodulation block has been reached (i.e., m=M), step 822 proceeds to step 826 and demodulation of the data packet is complete.

If the last demodulation block has not been reached, step 822 proceeds to step 824. At step 824, the demodulation block index m is incremented, and steps 808-824 are repeated until the last demodulation block is reached. Although not shown, it is understood that steps 800-826 may be repeated over a number of data packets associated with a data transmission.

Referring to FIGS. 3 and 4, in an alternative embodiment components receiver system 104 may be configured differently, for example, based on the parameter K (i.e., the number of demodulation stages) and the use of serial interference canceller 404. For example, K may be equal to 1 and serial interference canceller 404 may not used. Under such a configuration, demodulator 312 is referred to herein as a basic equalizer structure.

If the strength order of the data streams is known, use of optional serial interference canceller 404 may improve the performance. The performance of demodulator 312 may converge in about two or three stages, i.e., K=2 or 3.

The multi-stage IC may provide superior performance to either serial IC or parallel IC alone because it includes multiple iterations among channel estimation, time reversal-DFE, and interference cancellation. The multi-stage IC may remove the CoI for all data streams. In contrast, serial IC removes the CoI for weak data streams. With the increase of parallel IC stages, receiver system 104 performance improves. It is understood that the performance increase with the additional stages may also come with an increased complexity, because each symbol sequence is demodulated K times in the multi-stage IC process.

In MIMO receivers based on multichannel DFEs, feedforward filters are applied to individual hydrophone channels and their outputs are combined prior to the feedback filter. Feedback loops are used to remove interference from other transmitters for each data stream. Phase synchronization at the individual channels is optimized jointly with the equalizer tap weights. The number of equalizer taps increase linearly with the product of the transmitter number and the receiver number, N_{T}N_{R}. The complexity of this MIMO processor increases quadratically with the total number of tap coefficients if RLS algorithms are used for fast tracking of the channel. Therefore, the processing load becomes computationally prohibitive when the product N_{T}N_{R} becomes large.

As opposed to conventional multichannel DFE based MIMO receivers, receiver system 104 uses a single channel DFE after time reversal combining for each symbol sequence. One advantage of receiver system 104 includes its low complexity. Because time reversal combining mixes multiple channels into a single channel for individual symbol sequences, the complexity of the subsequent DFE remains unchanged when the number of hydrophones 302 increases. Furthermore, the single channel DFEs in receiver system 104 use a small number of equalizer taps to achieve an acceptable performance. In addition, because of the parallel IC techniques of receiver system 104 use to suppress the CoI, the complexity of the receiver system 104 may increase linearly only with the number of the transmitters N_{T} 102 (FIG. 1).

Communication system 100 (FIG. 1) may provide a high data rate MIMO communication for an underwater acoustic channel. At the source side, multiple transmitters 102 (FIG. 1) emit independent source symbols. The core demodulator of the MIMO receivers 104 uses time reversal combining followed by a single channel DFE to compensate for the ISI. At high carrier frequencies providing wide bandwidth (for example 16 kHz and 37.5 kHz), the acoustic channel may exhibit fast channel fluctuations. To compensate for these fast channel fluctuations, phase tracking and frequent channel MIMO tracking may be performed at individual channels, after Doppler correction. An exemplary multi-stage demodulator 312 may be used to effectively remove the CoI through the iterations of channel estimation, IC, and time reversal DFE.

Receiver system 104 uses limited bandwidth and does not employ ECCs. The extension of receiver system 104 for wide bandwidth may be achieved through the use of transmissions at multiple sub-bands, in which the same transmission, reception, and demodulation techniques may be used. These sub-bands may be separated in frequency to avoid inter-carrier frequency interference. To use ECCs, communication system 100 (FIG. 1) may use channel codes (e.g., convolutional codes, turbo codes, low density parity check codes) to encode the information at the source (on the transmitter 102 side). The corresponding channel decoder (on the receiver 104 side) may further enhance the accuracy of the recovered information through a decoder combined with the MIMO demodulation process described herein.

The present invention is illustrated by reference to two examples. The examples are included to more clearly demonstrate the overall nature of the invention. These examples are exemplary, and not restrictive of the invention.

### Makaiex Experiment

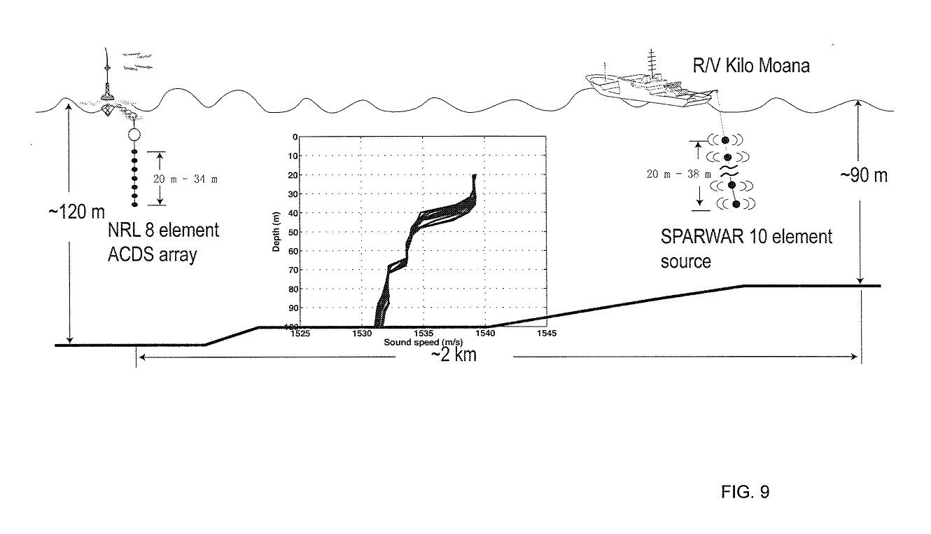

Referring to FIG. 9, a cross-section diagram of an example communication system in a shallow water region (during the Makai experiment (MakaiEx)) is shown with a SSP. MakaiEx was conducted in a shallow water region west of Kauai, Hawaii. A 10-element vertical MIMO source array and an 8-element receiving array were deployed.

In the experiment, a MIMO source was hung from the deck of the R/V Kilo Moana. A receiving array was deployed and allowed to drift in the ocean. During the acoustic transmissions, the R/V Kilo Moana maintained roughly a 2 km separation with the receiving array, which was drifting in deeper water. Both the source and receiving array had a spacing of 2 m with the top element about 20 m below the sea surface. The power level of each source element was 190 dB re 1 μPa at 1 m. The ocean environment was monitored during the acoustic transmissions. Two thermistor strings measured the water temperature profiles. Wind data were collected by the R/V Kilo Moana.

The water depth was about 90 m at the source and 120 m at the receiver. A strong wind (wind speed greater than 20 m/s) and a stratified water column condition were also observed. Because both the MIMO source and the receiving array were above the thermocline, it is expected that the acoustic channel may show significant fluctuations under such a dynamic environment.

The carrier frequency (f_{c}) of the communication data was 37.5 kHz and the symbol rate (R) was 4 kilo-symbols/s. A square-root raised cosine shaping filter was used with an excess bandwidth of 75%. The communication data were in the form of packets. A 1248 symbol long preamble preceded the data packet. 448 BPSK symbols were intermittently inserted into the data to re-train the receiver. The pilot training overhead is 35.9%. As will be shown further below, these training symbols were not necessary for most of data packets under optimized receiver configurations. The total length of the packet was about 2.5 s.

Three source configurations were used, i.e., one transducer, two transducers, and four transducers, to transmit binary phase shift keying (BPSK) and four phase shift keying (QPSK) signals. There were six types of signals specified by the transducer number and the modulation constellation. Each type of signal was transmitted for six packets. The 1-Tx packets used the transducer at the 28 m depth. The 2-Tx packets used transducers at depths of 26 and 32 m. The 4-Tx packets used transducers at the depths of 20, 26, 32, and 38 m. Accordingly, in these MIMO packets, the source separation was 6 m.

The discussion below is based on a common set of receiver parameters. In the exemplary MIMO equalizers (e.g., receiver system 104 (FIG. 3)), fractional spaced sampling signals were used and the over-sampling rate was Kₒₛ=3. There was no need to perform the Doppler correction because there was only slow platform movement (drifting source array/receiving array). The estimated length of the impulse response was 10 ms, or L=40 symbols. The channel estimation block size and phase observation block size were both set as N₀=N_{ξ}=3N_{T}L. The channel estimation update interval was chosen as 50 ms or N=200 symbols. The size of the preamble is N_{preamble}=1248 symbols. The feedforward filter span in symbols was N_{ff}=10 and the number of the feedback taps was N_{fb}=2. The RLS forgetting factor in the DFE was λ=0.999. In the PLL embedded in the DFE, the proportional tracking constant and the integral tracking constant were both set as K_{f1}=K_{f2}=0.0002.

The exemplary equalizer performed best when configured with a sparse MP channel estimator. In the MP algorithm, 20% of all the channel taps were estimated as the dominant paths, i.e.: P=0.2LN_{T}Kₒₛ. Table 1 shows the demodulation results for all data packets using the basic equalizer structure configured with the sparse MP channel estimator. All 1-Tx BPSK packets were demodulated with high output SNRs and without any errors. 2-Tx BPSK packets had low BERs, less than 7×10⁻⁴. With four data streams sharing the channel, 4-Tx BPSK packets had acceptable performance, with BERs of 4×10⁻² or less.

TABLE 1
DEMODULATION RESULTS OF THE BASIC RECEIVER STRUCTURE CONFIGURED
WITH THE SPARSE MP CHANNEL ESTIMATOR

| | | Packet Type | | | | | |
|---|---|---|---|---|---|---|---|
| | | Packet #1 | Packet #2 | Packet #3 | Packet #4 | Packet #5 | Packet #6 |
| 1TX | TX#1 | 16.6 dB | 11.4 dB | 15.6 dB | 15.2 dB | 15.4 dB | 14.6 dB |
| BPSK | BER | 0/5568 | 0/5568 | 0/5568 | 0/5568 | 0/5568 | 0/5568 |
| | | (0) | (0) | (0) | (0) | (0) | (0) |
| 2TX | TX#1 | 8.8 dB | 10.3 dB | 11.1 dB | 9.7 dB | 10.8 dB | 10.7 dB |
| BPSK | TX#2 | 9.5 dB | 8.3 dB | 8.9 dB | 10.5 dB | 9.5 dB | 9.6 dB |
| | BER | 2/10880 | 2/10880 | 4/10880 | 7/10880 | 4/10880 | 0/10880 |
| | | (0.0002) | (0.0002) | (0.0004) | (0.0007) | (0.0004) | (0) |
| 4TX | TX#1 | 4.8 dB | 3.1 dB | 3.4 dB | 4.4 dB | 4.8 dB | 5.5 dB |
| BPSK | TX#2 | 8.6 dB | 9.1 dB | 7.6 dB | 8.0 dB | 9.0 dB | 9.1 dB |
| | TX#3 | 7.9 dB | 6.3 dB | 6.5 dB | 6.8 dB | 7.6 dB | 7.3 dB |
| | TX#4 | 3.2 dB | 3.4 dB | 2.5 dB | 2.8 dB | 2.8 dB | 3.2 dB |
| | BER | 459/20960 | 739/20960 | 872/20960 | 584/20960 | 619/20960 | 457/20960 |
| | | (0.022) | (0.035) | (0.042) | (0.028) | (0.030) | (0.022) |
| 1TX | TX#1 | 15.7 dB | 17.4 dB | 13.2 dB | 17.0 dB | 14.3 dB | 12.0 dB |
| QPSK | BER | 0/11152 | 0/11152 | 2/11152 | 2/11152 | 02/11152 | 10/11152 |
| | | (0) | (0) | (0.0002) | (0.0002) | (0.0002) | (0.0009) |
| 2TX | TX#1 | 8.9 dB | 8.4 dB | 7.2 dB | 11.2 dB | 6.6 dB | 7.8 dB |
| QPSK | TX#2 | 8.6 dB | 8.7 dB | 9.4 dB | 10.6 dB | 9.8 dB | 10.8 dB |
| | BER | 121/22160 | 146/22160 | 184/22160 | 16/22160 | 361/22160 | 142/22160 |
| | | (0.006) | (0.007) | (0.009) | (0.0007) | (0.017) | (0.007) |
| 4TX | TX#1 | 3.6 dB | 5.3 dB | 7.7 dB | 6.1 dB | 4.2 dB | 5.5 dB |
| QPSK | TX#2 | 5.4 dB | 7.3 dB | 7.2 dB | 6.7 dB | 6.3 dB | 6.1 dB |
| | TX#3 | 6.5 dB | 6.1 dB | 6.3 dB | 8.8 dB | 9.5 dB | 4.6 dB |
| | TX#4 | 4.8 dB | 5.7 dB | 6.0 dB | 5.1 dB | 4.6 dB | 4.7 dB |
| | BER | 3086/41920 | 1645/41920 | 1153/41920 | 1442/41920 | 2308/41920 | 2638/41920 |
| | | (0.074) | (0.039) | (0.028) | (0.034) | (0.056) | (0.063) |

Using a higher modulation scheme, the 1-Tx QPSK packets were almost error-free. The 2-Tx QPSK packets had BERs of 10⁻² or less. 4-Tx QPSK packets had BERs below 7×10⁻².

Table 2 shows demodulation results for 2-Tx and 4-Tx packets for the receiver configured with sparse MP channel estimation and a three stage IC.

TABLE 2
PERFORMANCE OF THE MULTI-STAGE IC FOR 2- OR 4-TX PACKETS

| | | Packet Type | | | | | |
|---|---|---|---|---|---|---|---|
| | | Packet #1 | Packet #2 | Packet #3 | Packet #4 | Packet #5 | Packet #6 |
| 2TX | TX#1 | 12.8 dB | 12.7 dB | 13.7 dB | 13.5 dB | 14.2 dB | 14.3 dB |
| BPSK | TX#2 | 13.1 dB | 12.1 dB | 11.6 dB | 14.4 dB | 13.7 dB | 12.9 dB |
| | BER | 0/10880 | 0/10880 | 1/10880 | 1/10880 | 0/10880 | 0/10880 |
| | | (0) | (0) | (0.0001) | (0.0001) | (0) | (0) |
| 4TX | TX#1 | 9.2 dB | 7.6 dB | 7.3 dB | 8.4 dB | 8.7 dB | 9.9 dB |
| BPSK | TX#2 | 13.4 dB | 13.0 dB | 12.1 dB | 12.0 dB | 13.3 dB | 13.8 dB |
| | TX#3 | 12.9 dB | 9.6 dB | 10.2 dB | 11.2 dB | 12.0 dB | 12.2 dB |
| | TX#4 | 7.6 dB | 6.9 dB | 5.5 dB | 6.8 dB | 6.3 dB | 7.0 dB |
| | BER | 27/20960 | 91/20960 | 115/20960 | 50/20960 | 78/20960 | 49/20960 |
| | | (0.001) | (0.004) | (0.006) | (0.002) | (0.004) | (0.002) |
| 2TX | TX#1 | 13.3 dB | 12.1 dB | 11.1 dB | 15.0 dB | 10.9 dB | 11.3 dB |
| QPSK | TX#2 | 11.1 dB | 10.4 dB | 13.1 dB | 13.1 dB | 11.8 dB | 13.3 dB |
| | BER | 13/21760 | 38/21760 | 32/21760 | 7/21760 | 44/21760 | 22/21760 |
| | | (0.0006) | (0.002) | (0.002) | (0.0003) | (0.002) | (0.001) |
| 4TX | TX#1 | 7.2 dB | 9.3 dB | 11.2 dB | 10.0 dB | 8.2 dB | 8.5 dB |
| QPSK | TX#2 | 9.0 dB | 11.3 dB | 11.3 dB | 11.6 dB | 10.3 dB | 9.2 dB |
| | TX#3 | 9.8 dB | 10.1 dB | 10.0 dB | 12.2 dB | 12.5 dB | 7.0 dB |
| | TX#4 | 9.2 dB | 8.9 dB | 9.3 dB | 9.2 dB | 8.7 dB | 6.8 dB |
| | BER | 476/41920 | 244/41920 | 159/41920 | 153/41920 | 317/41920 | 1034/41920 |
| | | (0.011) | (0.006) | (0.004) | (0.004) | (0.008) | (0.025) |

Compared to Table 1, significant performance improvements may be observed. For most of 2-Tx and 4-Tx packets, 3-5 dB output SNR increase was achieved for each symbol sequence. The BERs were also significantly reduced, by nearly an order of magnitude. With the multi-stage IC, 2-Tx BPSK packets were nearly error-free. The 4-Tx BPSK packets were demodulated at the BER of 6×10⁻³ or less. The aggregate data rate of 4-Tx BPSK packets was 16 kbits/s. The corresponding bandwidth efficiency was 2.29 bits/s/Hz. The 2-Tx QPSK packets were demodulated at the BER of 2×10⁻³ or less. Most of 4-Tx QPSK packets had BERs below 10⁻². The data rate and the corresponding bandwidth efficiency of the 4-Tx QPSK packets were 32 kbits/s and 4.57 bits/s/Hz, respectively. These were high data rates and high bandwidth efficiencies achieved in the dynamic ocean environment.

Because the intermittent training symbols were BPSK symbols, it was possible to treat them as data symbols for the BPSK packets. Removing the intermittent training symbols did not affect the demodulation results for BPSK packets in terms of BERs and output SNRs since the BERs of these packets were small. Such a test was not possible for QPSK packets. It is expected that removal of the intermittent training symbols would not affect the demodulation results for any of the 1-Tx and 2-Tx QPSK packets or several of the 4-Tx QPSK packets, including 4-Tx QPSK Packets #2-5. The BERs of these packets were below 8×10⁻³.

### KAM08 Experiment

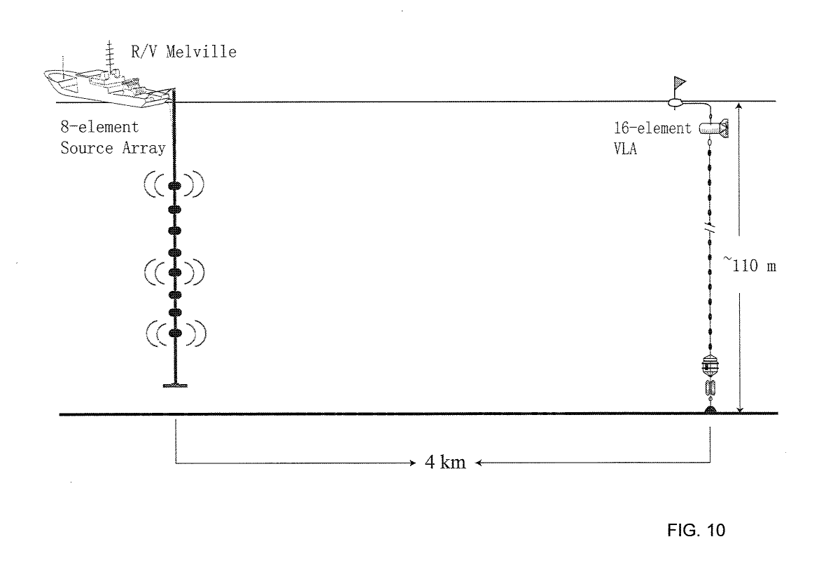

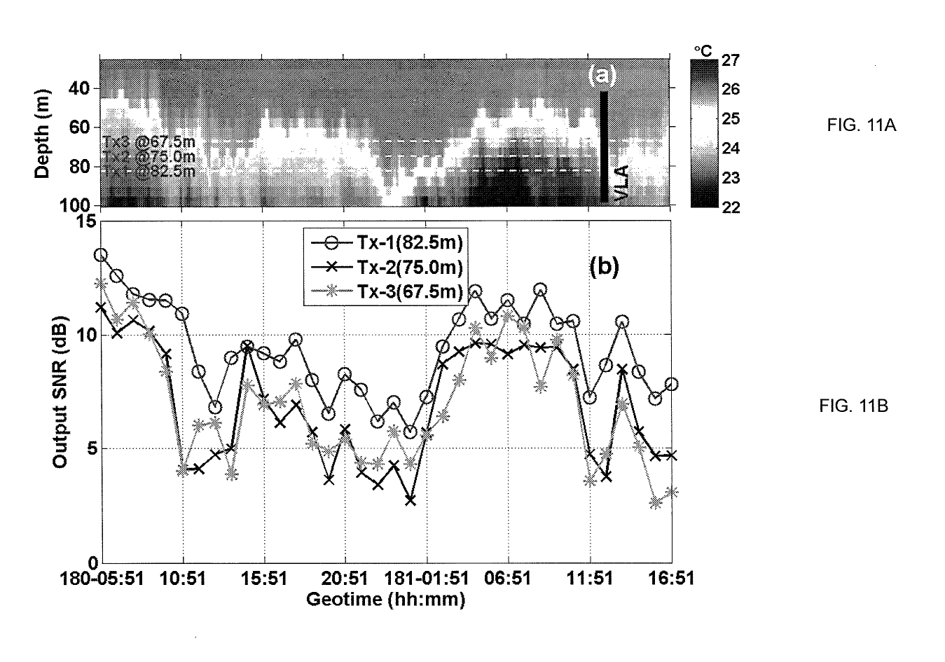

Referring next to FIGS. 10-11B, results from the KAM08 experiment are presented, which was also conducted west of Kauai, Hi. In particular, FIG. 10 is a cross-section diagram of an exemplary communication system used in the KAM08 experiment; FIG. 11A is a graph of the temperature profiles of the underwater environment with illustration of the positions of the transmitters and receivers; and FIG. 11B is a graph of output SNR as a function of geotime for demodulation of the data packets.

Along with the acoustic measurements, extensive environmental data were collected including wind, surface wave, and water column temperature profiles. The instruments and their locations as shown in FIG. 10 during one deployment discussed here, i.e., 35 hours from JD180 (Julian Day, June 28) 06:00 to JD181 (June 29) 17:00. An 8-element source array was deployed off the stern A-frame of the R/V Melville. The element spacing of the source array was 7.5 m with the top transducer at a 30 m depth. The source level was 185 dB re 1 μPa at 1 m. A 16-element vertical line array (VLA) was moored at a 4 km range from the source array along the 110 m depth isobath. Omni-directional transducers ITC-1001 and omni-directional hydrophones HTI-94 were used. The element spacing was 3.75 m with its 56.25 m aperture covering about half the water column. The bottom receiving element was positioned at 7.5 m above the sea floor. The sea surface was relatively calm, as evidenced by the significant wave height less than 1 m, during the 35-hour period. The water column typically was well-mixed down to at least 50 m depth whereas the entire water column was well-mixed around 3D181 00:00 as shown in FIG. 11A due to tidal internal waves.

The equalizer parameters are similar to those described above in the MakaiEx example, except for the impulse response length and channel estimation update interval. The estimated length of the impulse response was 100 ms, or L=400 symbols. The channel estimation block size and phase observation block size were both set as N₀=N_{ξ}=3N_{T}L. The channel estimation update interval was chosen as 100 ms or N=400 symbols. There was no need to perform the Doppler correction because there was minimum platform movement (the source ship in a dynamic positioning mode and the receiving array moored). The sparse LS algorithm (described above) was used. 20% of the full channel taps were estimated as being dominant, which were used in the time reversal DFE and multi-stage IC. The multi-stage IC performed time reversal DFE with serial interference cancellation at the first stage. Then time reversal DFE with parallel IC was iterated twice. Accordingly, K=3.

FIG. 11B shows the demodulation results for 3-Tx QPSK packets. Three transducers independently transmitted QPSK data streams each at the rate of 8 kilobits/s at the carrier frequency of 16 kHz at every hour during the 35 hour period. The source/receiver geometries are marked in FIG. 11A. We can envision the thermocline positioned roughly between the warm and cold water. Tx1 to Tx3 were mostly below the thermocline. As shown, the 3-Tx QPSK MIMO signaling schemes achieved data rates of 24 kilobits/s in FIG. 11B for 35 hours over a 6 kHz bandwidth for the 4 km source-receiver range. The BERs of 3-Tx QPSK packets were on the order of 10⁻² or less. The data rates, communication range, and communication reliability over the 35 hour period demonstrate the superiority of the exemplary MIMO equalizers of the present invention.

Although the invention has been described in terms of systems and methods for communicating in an underwater environment, it is contemplated that one or more components may be implemented in software on microprocessors/general purpose computers (not shown). In this embodiment, one or more of the functions of the various components may be implemented in software that controls a general purpose computer. This software may be embodied in a non-transitory tangible computer readable carrier, for example, a magnetic or optical disk, or a memory-card.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for communication in an underwater environment, the method comprising:
a) receiving signals at multiple receivers representing transmitted signals from multiple transmitters;
b) estimating channel responses between the multiple receivers and the multiple transmitters;
c) performing an initial demodulation process on the received signals using the estimated channel responses to remove inter-symbol interference (ISI); and
d) performing at least one subsequent demodulation process on the received signals: i) to remove co-channel interference (CoI) using the estimated channel responses and demodulated signals from an immediately preceding demodulation process to form interference cancelled signals and ii) to remove ISI from the interference cancelled signals.

2. The method according to claim 1, wherein the signal received at each of the receivers corresponds to a plurality signals transmitted from the multiple transmitters.

3. The method according to claim 1, further comprising, prior to step (c):
applying a Doppler correction on the received signals, based on a predetermined signal,
wherein the Doppler corrected signals are used to estimate the channel responses, to perform the initial demodulation and to perform the at least one subsequent demodulation process.

4. The method according to claim 1, further comprising, prior to step (c):
estimating a phase trend in the received signals; and
applying a phase correction to offset the received signals by the estimated phase trend, to form phase corrected signals,
wherein the phase corrected signals are used to estimate the channel responses, to perform the initial demodulation and to perform the at least one subsequent demodulation process.

5. The method according to claim 1, wherein step (b) includes estimating the channel responses using at least one of a least squares (LS) estimator, a sparse LS estimator and a matching pursuit (MP) estimator.

6. The method according to claim 1, further comprising:
updating the estimated channel responses based on the at least one subsequent demodulation process.

7. The method according to claim 1, wherein step (b) includes estimating dominant paths in the channel responses by sparse channel estimation.

8. The method according to claim 1, wherein removing the ISI includes:
applying time reversal filtering to one of the received signals and the interference cancelled signals using the estimated channel responses;
combining the filtered signals into a combined signal; and
applying decision feedback equalization (DFE) to adaptively correct the combined signal for the ISI.

9. The method according to claim 8, wherein removing the ISI includes:
removing a residual phase offset in one of the received signals and the interference cancelled signals.

10. The method according to claim 1, further including, prior to step (d), performing a serial interference cancellation process to suppress the CoI using initial demodulated signals produced by step (c), based on a signal strength of the received signals.

11. The method according to claim 1, wherein step (d) includes performing a plural number of subsequent demodulation processes.

12. A non-transitory computer-readable medium including computer program instructions that cause a program to perform the method according to claim 1.

13. A system for communication in an underwater environment, the system comprising:
multiple receivers configured to receive signals from multiple transmitters;
a channel estimator configured to estimate channel responses between the multiple receivers and the multiple transmitters; and
an interference canceling demodulator including:
a first stage demodulator configured to perform an initial demodulation process on the received signals using the estimated channel responses to remove inter-symbol interference (ISI); and
at least one subsequent stage demodulator block configured to perform a subsequent demodulation process on the received signals: i) to remove co-channel interference (CoI) using the estimated channel responses and demodulated signals from an immediately preceding demodulation process to form interference cancelled signals and ii) to remove ISI from the interference cancelled signals.

14. The system according to claim 13, further comprising a processor configured to control the channel estimator and the interference canceling demodulator.

15. The system according to claim 13, further comprising a Doppler corrector configured to apply a Doppler correction on the received signals,
wherein the Doppler corrected signals are used to estimate the channel responses, to perform the initial demodulation and to perform the subsequent demodulation process.

16. The system according to claim 13, further comprising a phase corrector configured to estimate a phase trend in the received signals and apply a phase correction to offset the received signals by the estimated phase trend, to form phase corrected signals,
wherein the phase corrected signals are used to estimate the channel responses, to perform the initial demodulation and to perform the subsequent demodulation process.

17. The system according to claim 13, wherein each of the first stage demodulator and the at least one subsequent stage demodulator includes:
time reversal filters for time reversal filtering of one of the received signals and the interference cancelled signals using the estimated channel responses;
a summing block for combining the filtered signals into a combined signal; and
a decision feedback equalizer to adaptively correct the combined signal for the ISI.

18. The system according to claim 13, wherein the interference canceling demodulator further includes a serial interference canceller to suppress the CoI using initial demodulated signals produced by the first stage demodulator, based on a signal strength of the received signals.

19. The system according to claim 13, wherein the signal received at each of the receivers corresponds to a plurality signals transmitted from the multiple transmitters.

20. The system according to claim 14,wherein the channel estimator includes at least one of a least squares (LS) estimator, a sparse LS estimator and a matching pursuit (MP) estimator.
